(19) United States
(12) Patent Application Publication
(10) Pub. No.: US 2010/0105309 A1
(43) Pub. Date: Apr. 29, 2010

(54) CLEAN UNIT, METHOD OF OPERATING CLEAN UNIT, AND CONNECTED CLEAN UNIT

(75) Inventor: Akira Ishibashi, Hokkaido (JP)

Correspondence Address: MOORE & VAN ALLEN PLLC, P.O. BOX 13706, Research Triangle Park, NC, 27709, US

(73) Assignee: C'STEC CORPORATION, Hokkaido (JP)

(21) Appl. No.: 12/596,886

(22) PCT Filed: Mar. 7, 2008
(86) PCT No.: PCT/JP2008/054685

§ 371 Date: Dec. 28, 2009

(30) Foreign Application Priority Data
Apr. 26, 2007 (JP) 2007-117205
Nov. 28, 2007 (JP) 2007-306847
Mar. 7, 2008 (JP) PCT/JP2008/054685

(51) Int. Cl. B01L 1/04; F24F 7/06; B01D 46/00

(52) U.S. Cl. 454/187; 454/49; 454/188

(57) ABSTRACT

In a clean unit which has a dust filter with a blowing power source on the upper surface of a working chamber and which can maintain a clean environment, an external gas flow passage is directly connected or connected through a partition wall, through which dust particles cannot pass but gas molecules can pass, to a feedback gas flow passage for connecting air-tightly a ventilation hole formed in the wall of the working chamber and the inlet of the dust filter to each other. On both sides of the partition wall, the flow velocity vector of a gas flowing in the feedback gas flow passage is made to be equal to the flow velocity vector of the gas flowing in an external gas flow passage.

### TECHNICAL FIELD

The present invention generally relates to a clean unit, a method of operating clean unit, and a connected clean unit, which are suitable for application to realize an environment which is capable of maintaining the number of dust particles such as dusts and germs below a predetermined value, or capable of maintaining a clean air environment without these dust particles, and capable of supplying enough oxygen.

### BACKGROUND ART

A clean room which removes dusts is required for the purpose of attaining high quality and improving yield of precision products for use in the electronics industry, the precision machine industry, and the detailed printing, etc. The International Technology Roadmap for Semiconductor (ITRS) announces that by the development of local cleanization, the requested cleanliness level of a clean room is eased to an environment of normal atmospheric level in 2018. However, present situation is far from the above environment level.

A technology that provides clean working space without using a clean room has already been proposed. For example, there is proposed as a working bench which makes it possible to work in a clean environment a working bench in which outside air is taken in through an opening of working space, the outside air is filtered through a filter, and the filtered air is blown out into the working space from the upper portion of the working space (see Japanese Patent Laid-open Publication No. 15984/1990). In the working bench, a communication route is provided at the lateral side or back side of working space to communicate between the working space and outside each other, object storage space is formed at the communication route, and an opening/closing mechanism to divide outside and the working space is provided at both sides of the object storage space.

Also, there is proposed a connected clean space apparatus in which a unit of room is connected in order, and clean space with constant volume as a whole is constructed (see Japanese Patent Laid-open Publication No. 106888/1993). Each unit of room of the connected clean space apparatus comprises air circulation means to circulate clean air in a unit, dust removing means. Installation space for air conditioning means shielding clean space is provided.

Also, there is proposed a connected clean space apparatus in which a unit of room with air circulation means, dust removing means, and air conditioning means are connected in order, and clean space with constant space is constructed as a whole (see Japanese Patent Laid-open Publication No. 223300/1993). In the connected clean space apparatus, a blower is provided at the opening to connect inside space of the unit of room so that air is blown in the direction intersecting the opening, or an open-close free door is provided at the opening to connect inside space of the unit of room.

Also, there is proposed a movable clean working chamber comprising an air purification portion which takes air and blows out clean air from a blow-off opening at the bottom surface into working area in the upper portion of the working chamber, and legs to support the air purification portion in the lower portion of the working chamber (see Japanese Patent Laid-open No. 123937/1988). The clean working chamber comprises leg-combining means to connect legs of each working chamber, and the air purification portion combining means to combine the air purification portion of each working chamber. The air purification portion combining means comprises a pair of combining members provided at the lateral side of the air purification portion, and combine vertically for the whole width of the lateral side. Combining portions in the vertical direction of at least one of the combining members comprises compressable sealing material. The working room is easily combined or separated.

Also, it is proposed to constitute a clean bench by disposing oppositely with clearance a blow unit which blows off clean air through a filter, and a drain unit which breathes air supplied by the blow unit through a filter (see Japanese Patent Laid-open No. 90576/2003).

Also, a clean unit which provides a perfect circulating-type closed construction and a connected clean unit are proposed (see the pamphlet of the International Publication No. 04/114378). According to the clean unit, a dust filter (HEPA (high efficiency particulate air) filter) with a blowing power source is provided at the upper portion of a working chamber capable of maintaining a clean environment of a clean unit in which connection ports are provided at least one of back, upper and bottom, and at least one side of the working chamber, respectively, and a tube with airtightness is directly connected to a side, etc. of the working chamber, and the tube is connected to the inlet of the dust filter so that the air is circulated. The mean value and highest value of cleanliness of the clean unit proves to be nearly Class 10. The clean unit is able to easily construct a desired clean unit system by connecting a plurality of units in broken-line formation, or in loop formation, according to a process to be executed using the connection ports. As described above, the mechanism to achieve high cleanliness by constructing clean units in circulation type is reported (see A. Ishibashi, H. Kaiju, Y. Yamagata and N. Kawaguchi: Electron. Lett. 41, 735 (2005) and H. Kaiju, N. Kawaguchi and A. Ishibashi: Rev. Sci. Instrum. 76, 085111 (2005)).

FIG. 1 schematically illustrates the clean unit. As shown in FIG. 1, in the clean unit, a dust filter 102 with a blowing power source is fixed at the upper surface of a working chamber 101. And a circulating duct 103 is fixed to connect between the inlet of the dust filter 102 and the working chamber 101, which enables to maintain the inside of the working chamber 101 a highly clean environment.

However, the conventional clean unit shown in FIG. 1 has a completely closed construction, so that outside air is not supplied. There is an issue that when creatures or cells are put in the working chamber 101, oxygen is consumed, as a result oxygen concentration of the working chamber 101 decreases. That is, in the closed circulating system, inside gas elements are consumed or new gas elements occur because of its airtightness so that there occurs another issue that the gas elements of an internal environment become completely different from the gas elements of the installation environment. For this, it is impossible for an operator to work in the working chamber 101 in safety for a long time, by enlarging the clean unit to an ordinal clean booth size.

On the contrary, it is very difficult to improve cleanliness of the conventional clean unit or clean booth in which an operator can enter, or the conventional clean unit costs a lot of money to improve cleanliness. Compared to a closed circulating type clean unit, the cleanliness of the conventional clean unit or clean booth is extremely low.

Therefore, a subject to be solved by the invention is to provide a clean unit capable of obtaining clean space with high cleanliness of Class 1 or more than 1 by very simple construction without having to use any large clean room, and also capable of maintaining the clean space to the same oxygen concentration with oxygen concentration of installation environment, and a method of operating the clean unit, and a connected clean unit using at least one clean unit which has aforementioned superiority.

### DISCLOSURE OF THE INVENTION

In order to solve the aforementioned subject, according to the first aspect of the present invention, there is provided a clean unit comprising:

a working chamber capable of controlling or maintaining the number of dusts or number of microbes in the working chamber, a part of the working chamber being constituted with a partition wall through which gas molecules can pass,

the flow velocity vector of gas inside the working chamber and the flow velocity vector of gas outside the working chamber being made to be almost symmetric at both sides of the partition wall at the vicinity of the partition wall.

The “being made to be almost symmetric at both sides of the partition wall” also can be expressed as “having nearly mirror symmetry with respect to the partition wall” (Hereinafter the same).

According to the second aspect of the present invention, there is provided a clean unit comprising:

a working chamber capable of controlling or maintaining the number of dusts or number of microbes in the working chamber,

a part of the working chamber being constituted with a partition wall through which gas molecules can pass,

the flow velocity vector of gas inside the working chamber and the flow velocity vector of gas outside the working chamber having finite magnitude and being made to be almost symmetric at both sides of the partition wall at the vicinity of the partition wall.

According to the third aspect of the present invention, there is provided A clean unit comprising:

a working chamber capable of controlling or maintaining the number of dusts or number of microbes in the working chamber; and

a gas flow passage for connecting air-tightly a ventilation hole formed in the working chamber and another ventilation hole formed in the working chamber,

an external gas flow passage being provided in contact with the gas flow passage, and the external gas flow passage and the gas flow passage communicating each other through a partition wall through which gas molecules can pass,

the flow velocity vector of gas inside the gas flow passage and the flow velocity vector of gas outside the external gas flow passage being made to be almost symmetric at both sides of the partition wall.

According to the fourth aspect of the present invention, there is provided a clean unit comprising:

a working chamber configured to be capable of closing and maintaining a clean environment inside of the working chamber;

a dust filter with a blowing power source provided in the working chamber; and

a gas flow passage to connect air-tightly a ventilation hole formed in the working chamber and the inlet of the dust filter,

the clean unit being configured so that all the gas flow from the ventilation hole of the working chamber enter into the inlet of the dust filter through the gas flow passage,

an external gas flow passage being provided in contact with the gas flow passage, and the external gas flow passage and the gas flow passage communicating each other directly or through a partition wall through which dust particles can not pass but gas molecules can pass.

“Dust particles can not pass” means that the partition wall does not pass any dust particles (100%), or that the partition wall may pass few particles (the blocking rate is not 100%) (Hereafter the same). More specifically, the blocking rate (passing rate) of dust particles is not necessarily valued 100% (0%), but at least 90% or more than 90% (less than 10%), and is preferably 99% or more than 99% (less than 1%).

While the dust filter means a filter using filter elements, the dust filter with a blowing power source stipulate especially that the dust filter has a blowing power source. More specifically, at the outside of the dust filter, a fan is installed with the dust filter in a unified manner or on the way of gas flow passage, a dust filter is fixed, and a fan is installed apart from the dust filter, which means to provide a blowing source power by the fan.

According to the fifth aspect of the present invention, there is provided a method of operating a clean unit comprising:

a working chamber configured to be capable of closing and maintaining a clean environment inside of the working chamber;

a dust filter with a blowing power source provided in the working chamber; and

a gas flow passage for connecting air-tightly a ventilation hole formed in the working chamber and the inlet of the dust filter,

the clean unit being configured so that all the gas flow from the ventilation hole of the working chamber enter into the inlet of the dust filter through the gas flow passage,

an external gas flow passage being provided in contact with the gas flow passage, and the external gas flow passage and the gas flow passage communicating each other directly or through a partition wall through which dust particles can not pass but gas molecules can pass,

wherein gases flow in the gas flow passage and the external gas flow passage with the same flow velocity.

When necessary, hereafter, the gas flow passage for connecting air-tightly a ventilation hole formed in the working chamber and the inlet of the dust filter is called a feedback gas flow passage.

According to the above third, forth, and fifth aspect of the present invention, the external gas flow passage, for example, is connected to outside air, and is in contact directly or through a communicating part via partition wal with a feedback gas flow passage attached to the working chamber. The gas molecules such as oxygen or the like are taken into the working chamber by diffusion directly or via partition wall through which dust particles can not pass (100%) but gas molecules can pass. However, by making the flow velocity vector of gas flowing in the feedback gas flow passage attached to the working chamber and the flow velocity vector of gas flowing in the external gas flow passage nearly equal, both flow velocity at both sides of the partition wall become equal, thus, the isobaric condition of Bernoulli's theorem holds. And macroscopic mass-flow through the partition wall disappears, so the invasion of dust particles from the external gas flow passage to the feedback gas flow passage is prevented, and the cleanliness of inside of the working chamber does not deteriorate.

According to the sixth aspect of the present invention, there is provided a clean unit comprising:

a working chamber configured to be capable of closing and maintaining a clean environment inside of the working chamber;

a dust filter with a blowing power source provided in the working chamber; and

a gas flow passage for connecting air-tightly a ventilation hole formed in the working chamber and the inlet of the dust filter,

the clean unit being configured so that all the gas flow from the ventilation hole of the working chamber enter into the inlet of the dust filter through the gas flow passage,

a partition wall through which dust particles can not pass but gas molecules can pass being provided at a part of at least one wall of the working chamber.

According to the seventh aspect of the present invention, there is provided a connected clean unit wherein a plurality of clean units capable of maintaining a clean environment are connected,

at least one clean unit comprising:

a working chamber configured to be capable of closing and maintaining a clean environment inside of the working chamber;

a dust filter with a blowing power source provided in the working chamber; and

a gas flow passage for connecting air-tightly a ventilation hole formed in the working chamber and the inlet of the dust filter,

the clean unit being configured so that all the gas flow from the ventilation hole of the working chamber enter into the inlet of the dust filter through the gas flow passage,

an external gas flow passage being provided in contact with the gas flow passage, and the external gas flow passage and the gas flow passage communicating each other directly or through a partition wall through which dust particles can not pass but gas molecules can pass.

The external gas flow passage is connected to outside air, for example.

According to the first to seventh aspects of the present invention, in case that the dust particle density is n(t), volume of the clean space or working chamber is V, the internal area of the space is S, the desorption rate of dust particles per area and per unit time is σ, dust density in an installation environment (outside air) where the clean unit is installed is N₀, and the dust collection efficiency of HEPA filter is γ, the dust particle density n(t) satisfies the differential equation, as theoretically shown by the inventor in aforementioned references (A. Ishibashi, H. Kaiju, Y. Yamagata and N. Kawaguchi: Electron. Lett. 41, 735 (2005)).

$$V \frac{d n ( t )}{d t} = S σ - n ( t ) F + n ( t ) F ( 1 - γ ) = S σ - γ Fn ( t )$$

The dust particle density n(t) in closed circulatory system is quite different from that of the conventional semi-open system clean room and is given by the following equation.

$$n ( t ) = \frac{S σ}{γ F} + ( {N}_{0} - \frac{S σ}{γ F} ) {e}^{- \frac{γ F}{V} t} \qquad ( 1 )$$

After time passes, the second member of equation (1) decreases to 1/e per time V/F according to the equation

$${e}^{- \frac{γ F}{V} t}$$

as γ is nearly 1, and rapidly comes near to zero, so that only the first term of equation (1), not including dust particle density of outside air, remains. That is, in a closed circulatory system, ultimate cleanliness can be obtained regardless of installation environment as shown by the following equation.

$$n = \frac{S σ}{γ F}$$

For example, when the height, width and depth of the clean unit are each 1 meter (V=1 m³), let perform closed circulation of the unit with flow rate F=1 m³/minute. The result is V/F=1 m³/(1 m³/minute)=1 minute, which proves that the number of particles reduces to about 1/2.8. Also, in case of a clean booth whose height, width and depth are each 2 meters, by using a fan unit with flow rate of 8 m³/minute (or by using four fan units with flow rate 2 m³/minute or the like), cleanliness of inside of the working chamber can be improved with the same time scale.

Especially, the dust particle density of a conventional clean room in steady state depends on the environment dust particle density N₀ and a high quality filter with the dust collection efficiency rate γ near to 1 is required. In contrast to this, according to the present invention, dust particle density n(t) in steady state does not depend on N₀ (regardless of installation environment) and γ appears in the denominator of the above equation (therefore it is not crucial that γ is nearly 1), so that quite high cleanliness can be realized even if using a cheap filter. Further, according to the present invention, gas elements of inside of the working chamber and gas elements of installation environment can be exchanged efficiently, so a perfect closed environment with regards to dust particles and an exchangeable environment by diffusion with regards to gas elements can be realized.

According to the first to seventh aspects of the present invention, a clean unit may be in any form and its form is selected from various forms as necessary. More specifically, the form may be a rectangular parallelopiped or cube, modified rectangular parallelopiped or cube. Basically, the internal volume of a working chamber is appropriately designed to meet an intended purpose. For the operator to be able to effect various kinds of work (carrying out a process, making maintenance such as cleaning, etc.) inside the working chamber with gloves on, for example, the working chamber, internal volume should desirably be such that the operator's hands inserted from outside, and the hands can desirably reach almost all positions of the entire working space in the working chamber. Generally, the size of the working chamber is selected within a size capable of putting in a room of ordinal dimension. On the other hand, if the size of the working chamber is too small, it will possibly prevent the operator from entering, putting living organisms, and working in it. For this, a size of 1 m or more than 1 m is selected, although the size is not limited to this. When an operator is not necessary to work in the working chamber, for example, in case the work can be effected automatically, or in case the clean unit containing samples or the like is carried, the working chamber may be designed smaller. The clean unit can be used for treatment of materials, chicken farming, sericulture, and microorganism cultivation, etc., for example. The treatment of materials includes treatments of various materials such as inorganic materials, organic materials, and biomaterial. In case of connecting a plurality of clean units, for example, the same kinds of processes appearing several times in a total series of process flow can be carried out in the same clean unit by providing connections of clean units in a loop arrangement in the plurality of clean units. On the other hand, when an operator enters and works in the working chamber, the width, height and depth of the working chamber are selected to be about 2 m and more than 2 m, although the dimensions are not limited to these.

In order to suppress generation of dusts from inside wall of the clean unit or the clean working chamber, for example, whole or a part of the inside wall may be coated with polytetrafluoroethylene.

When connecting a plurality of clean units, the connected clean unit includes, for example, a nanotechnology process unit and/or a biotechnology process unit.

When connecting clean units, connection ports are provided at least one of back, top and bottom, and at least one lateral side of the working chamber, respectively. Where the connection ports of the working chamber are provided, at the back, top, bottom, or at one of two lateral sides is appropriately selected depending upon how the clean units are disposed two-dimensionally (planar configuration) or three-dimensionally (sterical configuration). For example, when a connected clean unit is disposed on horizontal plane, preferably, the connection ports are provided at the back and both lateral sides of the working chamber respectively in order to increase freedom of the connection and to improve flexibility of the connected clean unit. In this case, it is possible to connect total three clean units to one clean unit at the back, and both lateral sides. And, when a clean unit is disposed on vertical plane, preferably, the connection ports are provided at the top or bottom and both lateral sides of the working chamber respectively in order to increase freedom of the connection and to improve flexibility of the connected clean unit. In this case, it is possible to connect total three clean units to one clean unit at top or bottom and both lateral sides. The connection ports have, for example, an opening formed on the wall of the working chamber, and a shield plate capable of opening or closing the opening. The shield plate may be basically any plate if it can be opened and closed. Typically, it is a sliding door or a hinged door. The opening and closing of the shield plate may be made manually. Alternatively, a sensor such as an optical sensor or the like may be provided in the working chamber, and open/close mechanism of the shield plate may be provided, so that the shield plate is automatically opened or closed when hands of an operator or a sample comes cross to the shield plate. Also, in case a transport mechanism such as a belt conveyor is provided in the working chamber, and a sample is carried between the entrance and exit by the transport mechanism, when the sample is carried to the vicinity of the exit by the transport mechanism, this is detected by a sensor and the shield plate may be opened or closed by open/close mechanism. The airtightness of breaking time may be improved by providing sealing materials like packing, etc on the wall of the shield plate or the working chamber.

Compact apparatuses can be set inside of the clean unit (or inside the working chamber) in accordance with the intended use. Specifically, the apparatuses are, for example, various kinds of processing apparatus, wrapping apparatus, analyzing apparatus (for example, an optical microscope, a scanning electron microscope (SEM), a scanning probe microscope (SPM) such as an atomic force microscope (AFM) or the like), a reaction apparatus, a micro chemical system, a micro chemical reactor, an exposure apparatus, an etching apparatus, a growth apparatus, processing equipment, a disinfection device, a grain diameter filter, an artificial light source, a bioapparatus, food processing equipment, an inspection apparatus, a medical device, parts of endoscope, a contact lenses producing device, a dialysis device, a medical disposable goods producing device, a medicine producing device or the like. The artificial light source is used for when cell lineage cultivation, plant cultivation, and gene testing are made, for example. When doing cell lineage cultivation, and plant cultivation, a light-emitting diode and a semiconductor laser with spectrum half bandwidth of less than 30 nm, especially a pulse-driven semiconductor laser are preferably used as artificial light source.

Also, an inside environment of the working chamber of the clean unit can be controlled by various methods. Controlling means of an inside environment is, for example, temperature control equipment, a humidity control system, gas component control equipment, adsorption equipment, a harm-removing apparatus, a specific wavelength illuminator, seal up/open selective mechanism or the like. The inside environment can be controlled by a computer, for example.

According to the connected clean unit, a material processing method which enables to carryout process of various kinds of materials easily at low cost with high flexibility corresponding to a total series of process flow for the fields of nanotechnology, biotechnology, plant factory technology, etc., a device manufacturing method which enables to carry out manufacturing process of various kinds of devices using inorganic or organic materials (LSI, light emitting diodes, semiconductor lasers or the like) easily at low cost with high flexibility corresponding to a total series of process flow, a plant cultivation method which enables to carry out plant cultivation process easily at low cost with high flexibility corresponding to a total series of process flow or the like. Also, poultry farming, pig farming, etc. eliminating air infectiveness microbes can be realized, which enables to reduce menace for human society by parasitic zoonosis. In case of SARS outbreak in neighboring area, disposition of cultivating chickens is not required.

### BRIEF DESCRIPTION OF THE DRAWINGS

FIG. 1 is a front view of a conventional clean unit.

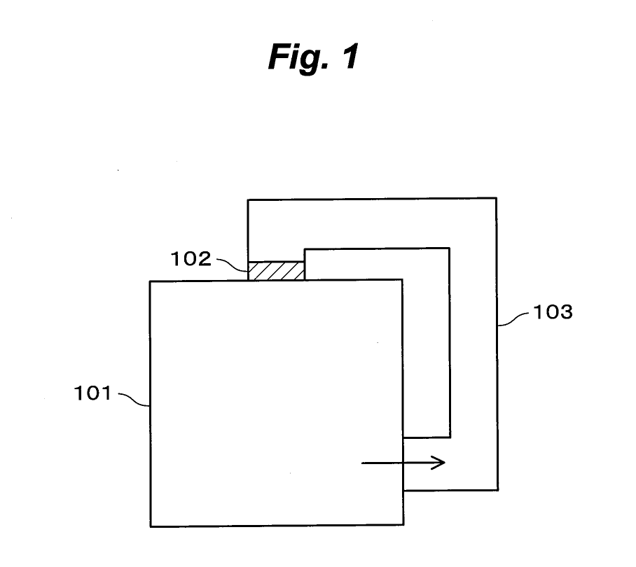

FIG. 2 is a cross-sectional diagram of a clean unit according to the first embodiment of the present invention.

FIG. 3 is a cross-sectional diagram of a clean unit according to the second embodiment of the present invention.

FIG. 4 is a front view of a clean unit according to the third embodiment of the present invention.

FIGS. 5A and 5B are a plan view and a side elevation of the clean unit according to the third embodiment of the present invention.

FIGS. 6A and 6B are a front view and its partially enlarged illustration of an apparatus by which particle counting and measurement of the rest of oxygen are carried out in the third embodiment of the present invention.

FIG. 7 is a schematic view illustrating experiment results (γ=99.99985%) of time dependency of counts of dust particles and the rest of oxygen.

FIG. 8 is a schematic view illustrating experiment results (γ=98%) of time dependency of counts of particles and the rest of oxygen.

FIG. 9 is a schematica view illustrating experiment results (γ=90%) of time dependency of counts of particles and the rest of oxygen.

FIG. 10 is a schematic view illustrating experiment results (γ=65%) of time dependency of counts of particles and the rest of oxygen.

FIG. 11 is a schematic view illustrating experiment results (γ=0%) of time dependency of counts of particles and the rest of oxygen.

FIG. 12 is a schematic view illustrating the attenuation of particles without a candle.

FIG. 13 is a schematic view illustrating experiment results of γ (the collection efficiency of a partition wall) dependency of arrival time to zero count.

FIG. 14 is a schematic illustrating experiment results of γ (the collection efficiency of a partition wall) dependency of the relative oxygen concentration.

FIG. 15 is a schematic view illustrating experiment results in case a dust counter is put in an unenclosed structure clean unit.

FIGS. 16A and 16B are front views of a clean booth according to the fifth embodiment of the present invention.

FIG. 17 is a front view of a connected clean unit according to the sixth embodiment of the present invention.

### BEST MODE FOR CARRYING OUT THE INVENTION

The present invention will be explained in detail below concerning the embodiments thereof with reference to the accompanying drawings.

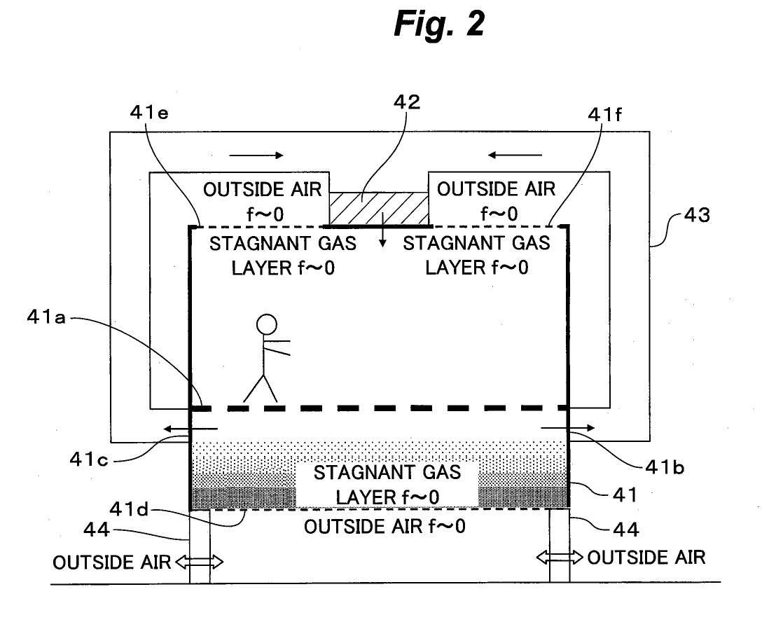

FIG. 2 is a cross-sectional view of a clean unit (clean booth) according to the first embodiment of the present invention.

As shown in FIG. 2, the clean unit has a working chamber 41 with a size in which an operator can enter, and the working chamber 41 has a porous raised floor 41a which permits gas mass flow. The clean unit has a feedback gas flow passage 43 for connecting air-tightly ventilation holes 41b and 41c formed on the wall of the working chamber 41, just under the raised floor 41a and an inlet of a dust filter (a fan filter unit) 42 with a blowing power source provided on top surface (ceiling surface) of the working chamber 41. The raised floor 41a is situated on high position from the base 41d of the working chamber 41. The ventilation holes 41b and 41c which take air into the feedback gas flow passage 43 are located just under the raised floor 41a. Therefore, a stagnant gas layer is formed at the base 41d of the working chamber 41. Accordingly, there is no macroscopic gas flow here, and the gas velocity vector f˜0. The base 41d of the working chamber 41 is constructed with a board through which dust particles can not pass (100%) but gas molecules can pass. Therefore, the diffusion of gas molecules consisting the gas of the upper and under the base 41d occurs freely to make concentration gradient to zero if there exists finite concentration gradient. The air velocity vector f of just under the base 41d of the working chamber 41 satisfies f˜0. By this, the mass flow of gas penetrating the base 41d of the working chamber 41 is zero. On the other hand, the base 41d of the working chamber 41 is set up at higher position than the floor position of the room in which the clean unit is installed by pillars 44 to permit lateral sides gas flow moving. Therefore, the air elements just under the base 41d of the working chamber 41 is the same as the air elements of the whole room. Accordingly, the base 41d of the working chamber 41 can be set up such that exchange of dust particles does not occur, but exchange of molecules of gas elements occurs. The same circumstances described above can be realized at the top surfaces 41e and 41f of the working chamber 41.

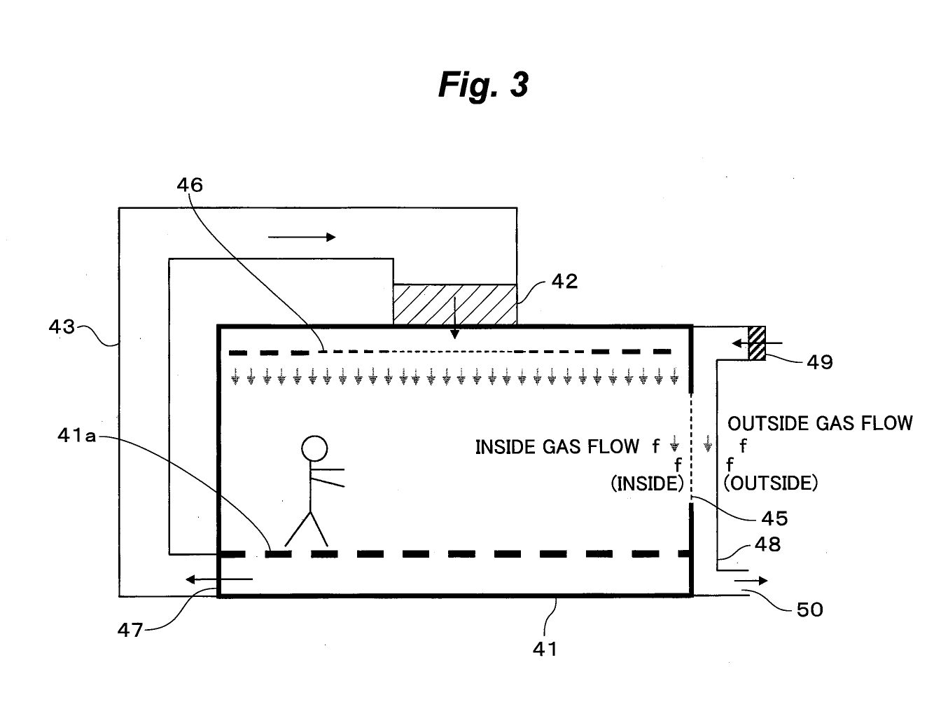

FIG. 3 is a cross-sectional view of a clean unit (clean booth) according to the second embodiment of the present invention.

As shown in FIG. 3, the clean unit has the working chamber 41 with a size in which an operator can enter, and the working chamber 41 has a partition wall 45 through which dust particles can not pass (100%) but gas molecules can pass. A homogeneous flow formation board 46 provided on just under the top surface (ceiling surface) of the working chamber 41 is set so that the gas permeability is low just under the dust filter 42 provided at top surface of the working chamber 41, and the opening gradually becomes larger with increasing distance from the dust filter 42 to lateral direction (horizontal direction), and gas permeability increases to make gas flow flowing downward in case viewing from top surface, becomes even. The clean unit has the feedback gas flow passage 43 for connecting air-tightly the ventilation hole 47 formed on the wall of the working chamber 41 and the inlet of the dust filter 42 disposed on top surface of the working chamber 41. In this case, there exists downward gas flow along the sidewall of the working chamber 41. The gas velocity vector is f (inside)≠0, that is, the gas velocity vector has a finite magnitude. In the clean unit, the external gas flow passage 48 is provided at the outside of sidewall of the working chamber 41. The sidewall of the working chamber 41 is in contact with the external gas flow passage 48, and the partition wall 45 is constructed with the board through which dust particles can not pass (100%) but gas molecules can pass. Therefore, the diffusion of gas molecules constituting the gas elements at the both sides of the partition wall 45 is generated freely to make concentration gradient to zero if there exists finite concentration gradient. The flow rate of an air blower 49 is controlled so that the air flow velocity vector f (outside) of the external gas flow passage 48 provided in contact with sidewall of the working chamber 41 satisfies f (outside)˜f (inside). The gas flowing in the external gas flow passage 48 is discharged through a vent 50. By making the flow velocity vector f (inside) of gas flowing along the sidewall of the working chamber 41 almost the same with the velocity vector f (outside) of gas flowing in the external gas flow passage 48, the gas flow velocity becomes nearly equal at both sides of the partition wall 45, and the isobaric condition of Bernoulli's theorem holds. As macroscopic mass-flow of gas penetrating through the partition wall 45 disappears, invasion of dust particles into the working chamber 41 through the external gas flow passage 48 is prevented, and cleanliness in the working chamber 41 does not deteriorate. Accordingly, the sidewall of the working chamber 41 can be set up so that exchange of dust particles does not occur but exchange of molecules of gas element occurs.

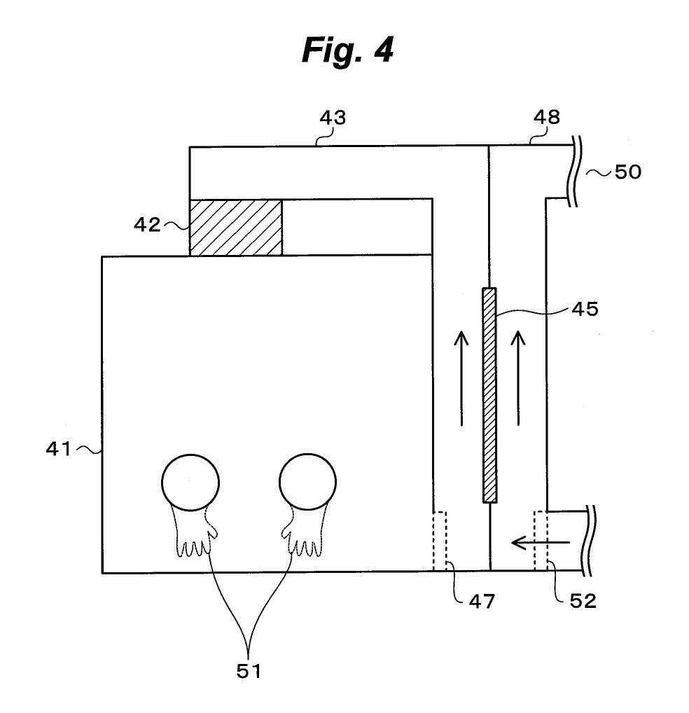

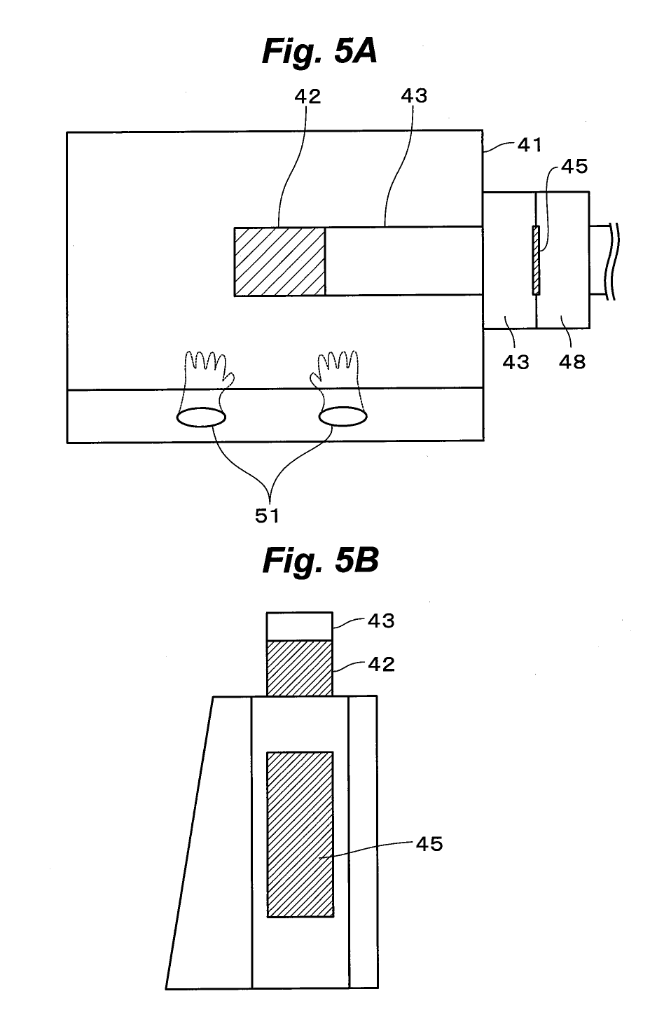

FIG. 4 is a front view of a clean unit according to the third embodiment of the present invention, and FIGS. 5A and 5B are a plan view and side elevation of the clean unit.

As shown in FIGS. 4, 5A and 5B, the clean unit has a hexagonal box shaped working chamber 41. The both sidewalls of the working chamber 41 are parallel each other, and top surface and bottom surface are parallel each other, and both sidewalls and top surface, both sidewalls and bottom surface, both sidewalls and front surface, and both sidewalls and back surface are at right angle each other. The front surface is non-parallel to back surface, and the upper part of top surface is tilted at a predetermined angle in the direction approaching to back surface, for example, 70 to 80 degrees, but the angle is not limited to this. As the front surface of the working chamber 41 is detachable so that the front being detached, necessary apparatus such as a process apparatus and an observation apparatus, etc. can be introduced into the working chamber 41.

To minimize discharge of dusts from the inside wall of the working chamber 41, in space frequency, preferably, the inner surface of the working chamber 41 may be smoothed not to have any Fourier component of a surface roughness on the same order as the diameter of the dust particle to be removed from the working chamber 41, to thereby minimize the absorption of dust particles having the size of the to-be-removed dust particles to the inner surface of the working chamber 41. To control the discharge of dusts from the inside wall of the working chamber 41, preferably, the whole or part of the inside wall surface may be coated with polytetrafluoroethylene, for example.

Two circular openings are provided at the front wall of the working chamber 41, and at the openings a pair of manipulation-use gloves 51 is provided. And an operator can do any necessary work inside of the working chamber 41 with the hands being inserted in the manipulation-use gloves 51. When necessary, it is possible to decide the size of the working chamber 41 for an operator to be able to enter, but in this case a pair of manipulation-use gloves 51 is not attached.

The size of the working chamber 41 is selected large enough to accommodate necessary process apparatus, etc. and for an operator to make necessary work in the working chamber 41 with the hands being inserted in the manipulation-use gloves 51. In case an operator does not enter in the working chamber 41, the dimensions of the working chamber 41 are 50 to 70 cm in depth, 70 to 90 cm in width, and 50 to 100 cm in height, for example, but the dimensions are not limited to these. In case an operator enters into the working chamber 41, generally a dimension of order of 1 m is selected for the depth, width and height respectively, typically 2 to 10 m is selected for the depth, width and height, respectively. The materials which constitute the working chamber 41 are metal such as stainless steel, etc. with less dust discharge and high mechanical strength, or acrylate resin boards, but the materials are not limited to these. In case using acrylate resin boards of transparent material, it is possible to make the inside of the working chamber to be visible from outside.

The dust filter 42 with a blowing power source is fixed at the top surface of the working chamber 41, and the feedback gas flow passage 43 is fixed to connect between the inlet of the dust filter 42 and the ventilation hole 47 provided at the bottom of the working chamber 41, which enables to maintain the inside of the working chamber 41 a high cleanliness environment, for example, approximately the ISO class-1 to 3. As the dust filter 42, for example, a HEPA filter using glass fiber as filter material or a ULPA filter using polytetrafluoroethylene as filter material are used.

The external gas flow passage 48 is provided in contact with the feedback gas flow passage 43, and the feedback gas flow passage 43 and the external gas flow passage 48 are communicated with each other directly or through a partition wall 45. A fan 52 is fixed at the outside air intake provided on bottom of the external gas flow passage 48, and an exhaust opening 50 is provided at the top of the external gas flow passage 48. Outside air can be taken by the fan 52 and discharged outside air through an exhaust opening 50. The partition wall 45 is made of such materials through which dust particles can not pass but gas molecules such as oxygen, etc. can pass, and dust filters such as a HEPA filter and a ULPA filter, a gas barrier film, or porous sponge materials, etc. to be used for food packaging materials, or seal materials (a tape made of polytetrafluoroethylene, etc.) for connection of plumbing to prevent leakage of gas may be used.

Next, an example of method of operating the clean unit will be explained below.

By starting operation of the dust filter 42 and the fan 52 fixed to the external gas flow passage 48, the air in the working chamber 41 enters into the inlet of the dust filter 42 through the feedback gas flow passage 43, the dust particles are eliminated, and the air is purified. At the same time, the outside air enters into the external gas flow passage 48 by the fan 52, then the air is exhausted from the exhaust opening 50. At the moment, at the vicinity of the partition wall 45, by making the flow velocity vector of gas flowing in the feedback gas flow passage 43 nearly equal to the flow velocity vector of gas flowing in the external gas flow passage 48 each other, the gas in the feedback gas flow passage 43 and the gas in the external gas flow passage 48 flow with the same velocity. According to the isobaric condition of Bernoulli's theorem, macroscopic mass-flow penetrating through the partition wall 45 disappears. Therefore, there is no gas flow into the feedback gas flow passage 43 from the external gas flow passage 48, and dust particles contained in the outside air are not taken into the working chamber 41 through the feedback gas flow passage 43. As a result, the working chamber 41 is maintained high cleanliness, and oxygen taken from outside air flows into the feedback gas flow passage 43 penetrating through the partition wall 45 by diffusion, and the oxygen concentration in the working chamber 41 can be maintained to the same concentration of the outside air. Similarly, when there is carbon dioxide increased inside of the working chamber 41, the carbon dioxide flows into the external gas flow passage 48 penetrating through the partition wall 45 by diffusion and the carbon dioxide is exhausted outside through the exhaust opening 50 of the external gas flow passage 48. Therefore, the carbon dioxide concentration in the working chamber 41 can be maintained to the same concentration of the outside air.

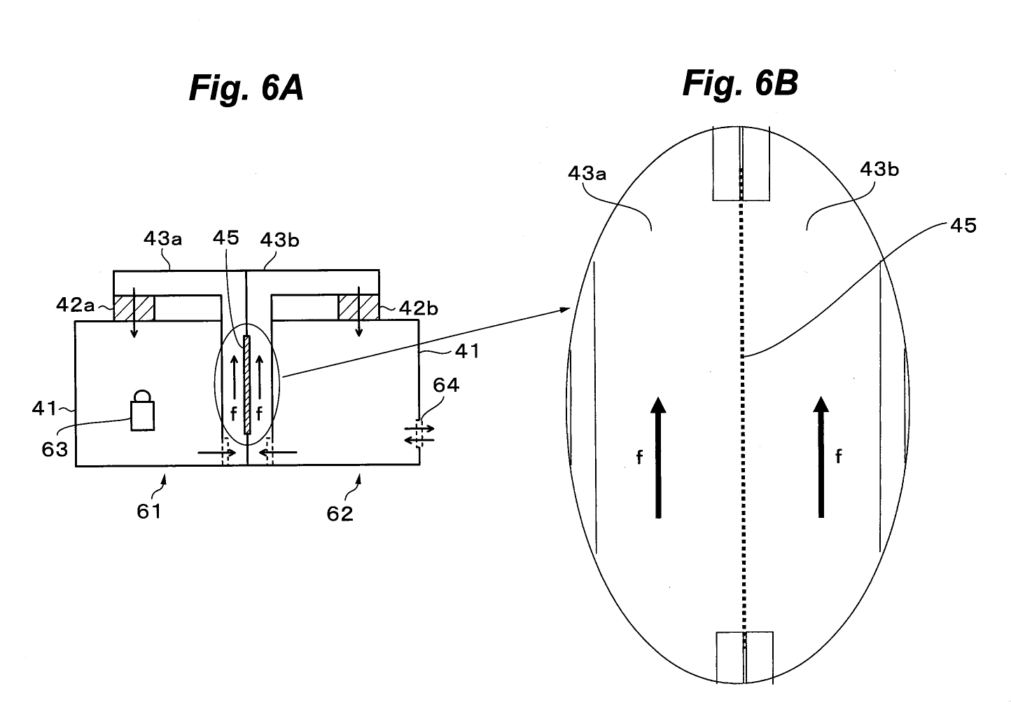

The time dependency of the number of dust particles and the rest of oxygen of the clean unit is measured. The configuration of apparatus, by which the experiment is carried out, is shown in FIGS. 6A and 6B. As shown in FIG. 6A, the two same type clean units (a clean unit 61 and a clean unit 62) are connected via the feedback gas flow passages 43a and 43b. These cleans unit 61 and 62 are put in a room of normal environment, and each clean unit is filled with air. The volume V of the working chambers of the clean units 61 and 62 is about 0.4 m³ each and the flow rate F of the dust filters 42a and 42b is 0.4 to 0.9 m³ per minute. The feedback gas flow passages 43a and 43b are about 1 m in length, about 30 cm in width and about 1 cm in thickness, and have same configuration and are appressed to each other. The feedback gas flow passages 43a and 43b show mirror symmetry for appressed surfaces (contact surfaces). Openings of 30 cm in height, 21 cm in width are provided at each of the feedback gas flow passages 43a and 43b, and the partition wall 45 with the same dimensions of the openings is provided between these openings. The air flows in the feedback gas flow passages 43a and 43b with the same flow rate 0.4 to 0.9 m³ per minute. The clean unit 61 is closed and a dust counter 63 is put in the working chamber 41. An opening 64 is formed on the wall of the working chamber 41 of the clean unit 62, and the working chamber 41 is connected to outside via the opening 64. The feedback gas flow passages 43a and 43b show mirror symmetry for appressed surfaces. The flow rate of the air flowing each feedback gas flow passage is the same. Therefore, the flow velocity vector f of the air flowing in the feedback gas flow passages 43a and 43b have mirror symmetry for appressed surfaces, which is symmetry with respect to appressed surfaces. Especially, as shown in FIG. 6A the feedback gas flow passages 43a and 43b extend in perpendicular direction (vertical direction: z direction) to the floor, and in case at the vicinity of the opening, there is translation symmetry of vertical direction with good proximity, the aforementioned vector f becomes a function of only x and y of the cross-sectional plane (xy plane). Also, in case the gas (air) flows with the flow rate not causing turbulent flow, the gas flow in the plane becomes uniform and nearly constant, not depending on x and y. The wind velocity v is given by v=F/A when the cross-sectional area of the feedback gas flow passages 43a and 43b is A, and based on aforementioned operating condition, v has a value of about 4 m/s. In case not satisfying the translation symmetry, the feedback gas flow passages 43a and 43b are made symmetry with respect to the appressed surfaces, the flow velocity vector f (x, y, z) of air flowing also has mirror symmetry for the appressed surfaces.

One embodiment of the part of the partition wall 45 shown in FIG. 6A is shown in FIG. 6B. By sandwiching the partition wall 45 made of partition wall materials such as a HEPA filter, etc. between the boards materials constituting the feedback gas flow passages 43a and 43b (both have the same thickness), the symmetry construction can be realized reproducibly.

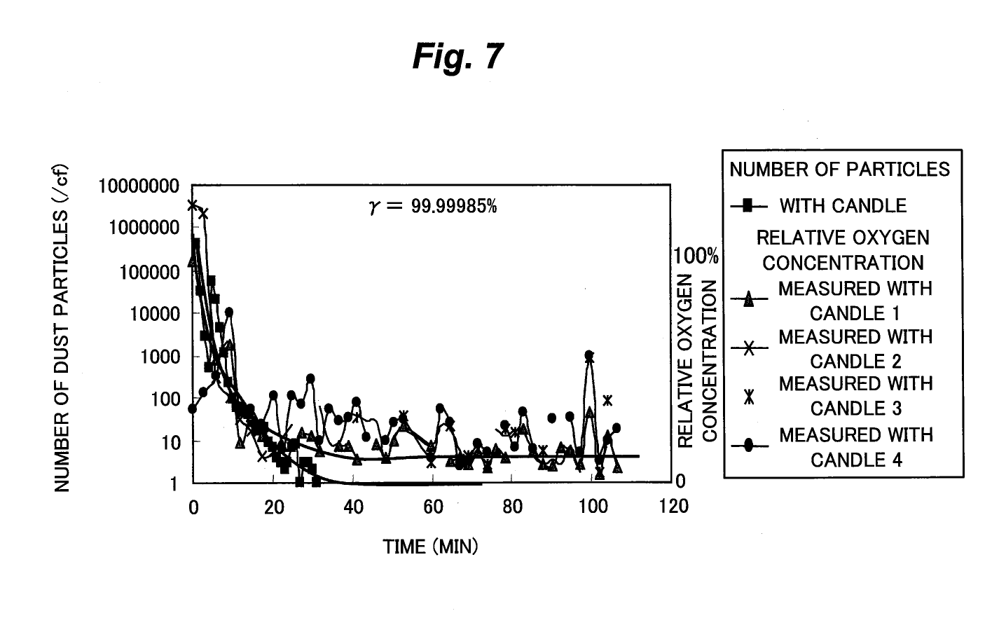

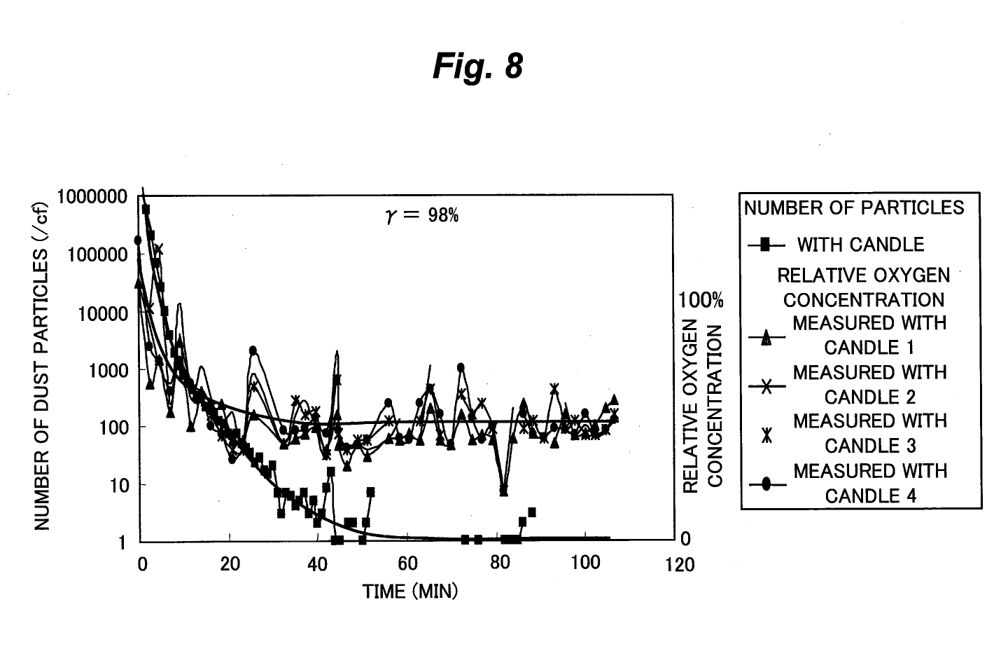

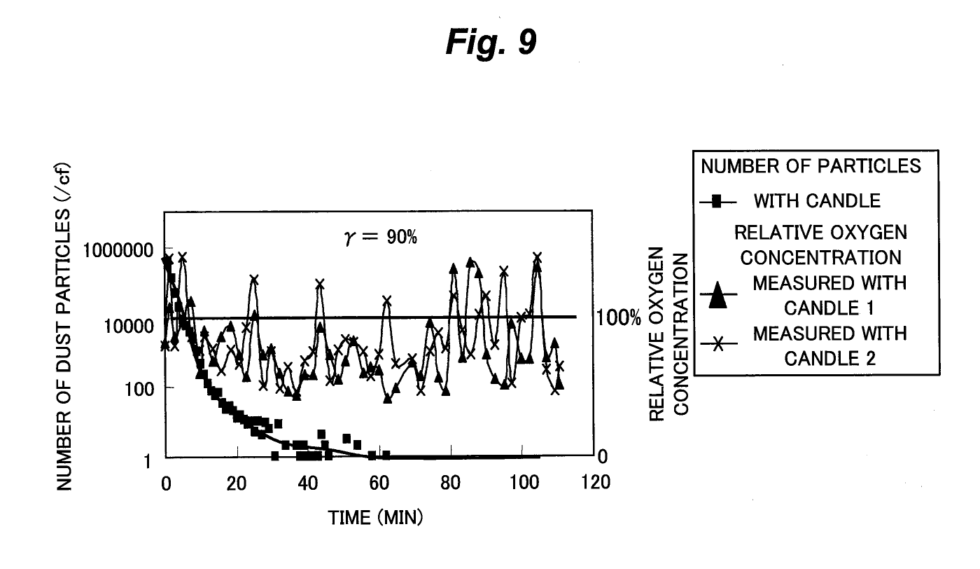

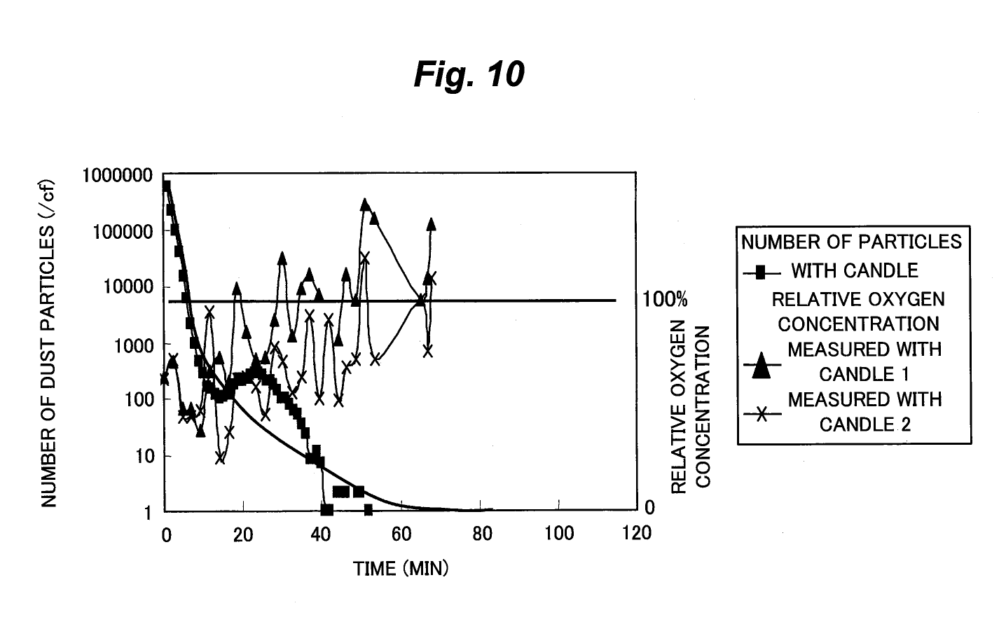

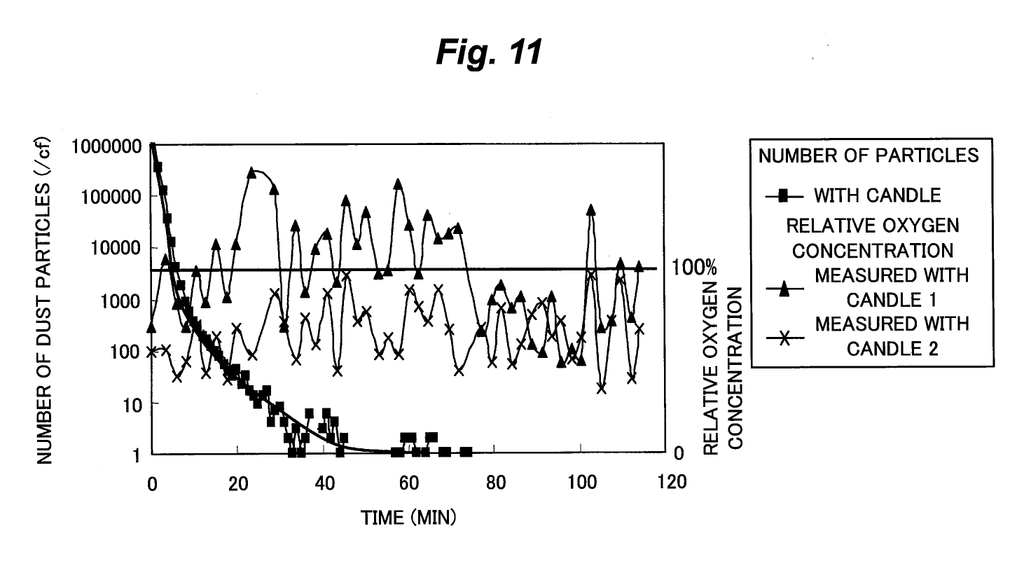

FIGS. 7, 8, 9, 10 and 11 show the time dependency of the count number of dust particles and the rest of oxygen in the working chamber 41 of the clean unit 61, in case operating the clean units 61 and 62 by changing the dust collection efficiency γ of the partition wall 45 shown in FIG. 6A. FIG. 7 shows the result when γ is 99.99985%, FIG. 8 shows the result when γ is 98%, FIG. 9 shows the result when γ is 90%, FIG. 10 shows the result when γ is 65%, and FIG. 11 shows the result when γ is 0% (open). In case γ is 99.99985% (FIG. 7), the arrival time to zero count of dust is about 20 minutes, comparing to oxygen concentration in an unenclosed environment, the relative oxygen concentration after passing enough time reduces to about a few percent of the oxygen concentration of the unenclosed environment. In case γ is 98% (FIG. 8), the arrival time to zero count of dust is about 40 minutes, the relative oxygen concentration after passing enough time reduces to about 40%. In case γ is 90% (FIG. 9), the arrival time to zero count of dust is about 40 minutes, comparing to the oxygen concentration in the unenclosed environment, the relative oxygen concentration maintains 100% even after passing enough time. In case γ is 65% (FIG. 10), the arrival time to zero count of dust is about 40 minutes, the relative oxygen concentration maintains 100% after passing enough time. In case γ is 0% (FIG. 11, without a filter), the arrival time to zero count of dust is also about 40 minutes, the relative oxygen concentration maintains 100% even after passing enough time. Summarizing aforementioned results, the smaller the dust collection efficiency γ is, the longer the arrival time to zero count becomes, but the relative oxygen concentration tends to increase. In case using partition wall materials of about A4-size area (about 0.06 m²) for sidewall area of about 0.4 m² through which gas molecules can pass, and in case the γ is less than or equal to 90%, the number of dust reaches to zero in about 40 minutes, which shows that the relative oxygen cocentration can be maintained to 100%. As the dust collection efficiency γ comes closer to 1, the easiness of permeability of gas molecules becomes small. The easiness of permeability of gas molecules is proportional to 1-γ with good approximation. The practical volume of exchange of gas molecules is decided by the product of the area of partition wall S and permeability easiness of gas molecules in partition wall materials. Accordingly, using aforementioned value of γy, quantitative design can be done based on aforementioned experiment results, as a function of the area S of partition wall materials. That is,

γ′=1−S(1−γ)/S′

Based on the above equation, prospective design can be done even if the dust collection efficiency and area S are different in value.

The dust counter 63 used here is LASAIR310 and LASAIR110 made by Particle Measuring Systems Inc. Oxygen consumption in the working chamber is made by a lighted candle, the relative oxygen concentration in the working chamber is calculated by measuring the size (volume) of flame of the candle provided in the working chamber.

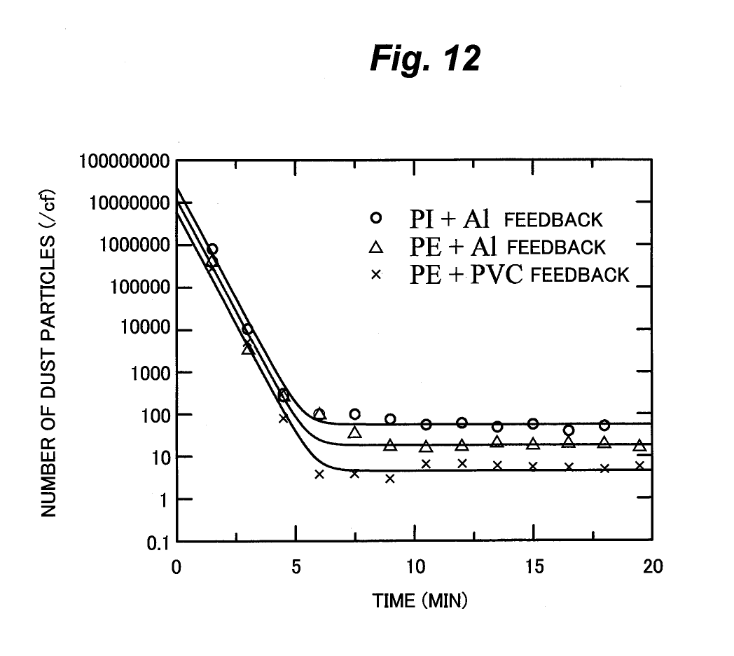

FIG. 12 shows attenuation state of number of dust particles without a candle. The volume V of the working chamber 41 is 0.4 m³, and the flow velocity F of the feedback gas flow passages 43a and 43b is 0.9 m³ per minute. In FIG. 12, the data shown with a circle indicates a case where the material of a pair of manipulation-use gloves 51 (not shown in FIGS. 6A and 6B) attached to the working chamber 41 is polyisoprene rubber (PI), and the feedback gas flow passages 43a and 43b are made with accordion pipes made of matted aluminium (AI), the data shown with a triangle indicates a case where the material of the pair of manipulation-use gloves 51 is polyethylene (PE) and the feedback gas flow passages 43a and 43b are made with accordion pipes made of matted aluminium (AI), and the data shown with an x indicates a case where the material of the pair of manipulation-use gloves 51 is polyethylene (PE) and the feedback gas flow passages 43a and 43b are made with poly (vinyl chloride) (PVC). In these cases, as there are no soot emissions from a candle, the number of dust particles reaches steady states in about eight minutes, earlier compared to the results shown in FIGS. 7, 8, 9, 10 and 11. Also, as shown in FIG. 12, it can be confirmed that attained cleanliness level differs depending upon the materials of the pair of manipulation-use gloves 51 of the working chamber 41 and the materials of the feedback gas flow passages 43a and 43b.

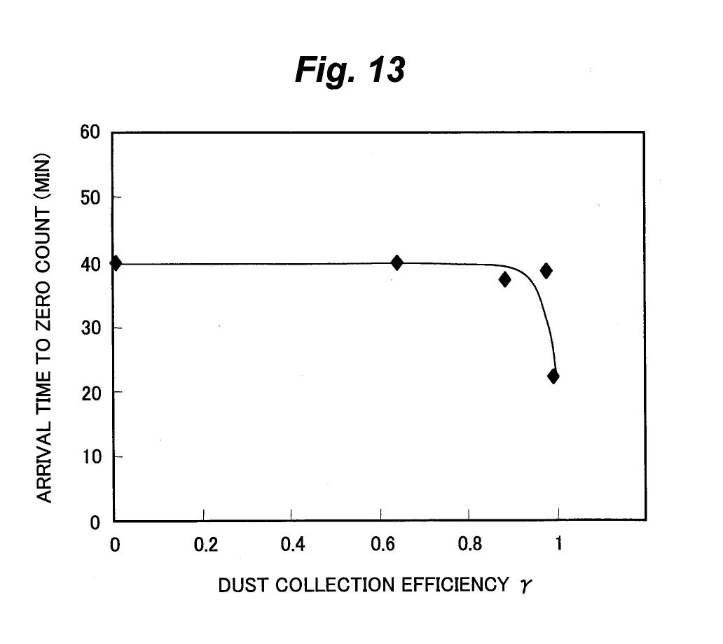

FIG. 13 shows the dust collection efficiency γ dependency of the arrival time to zero count of dust particles. In case using partition wall materials of about A4-size area (about 0.06 m²) for sidewall area of about 0.4 m² through which gas molecules can pass, and in case the γ is 100%, the dust particles reaches to zero count in about 20 minutes, which shows that the γ is even less than or equal to 90%, the dust particles reaches to zero count in about 40 minutes.

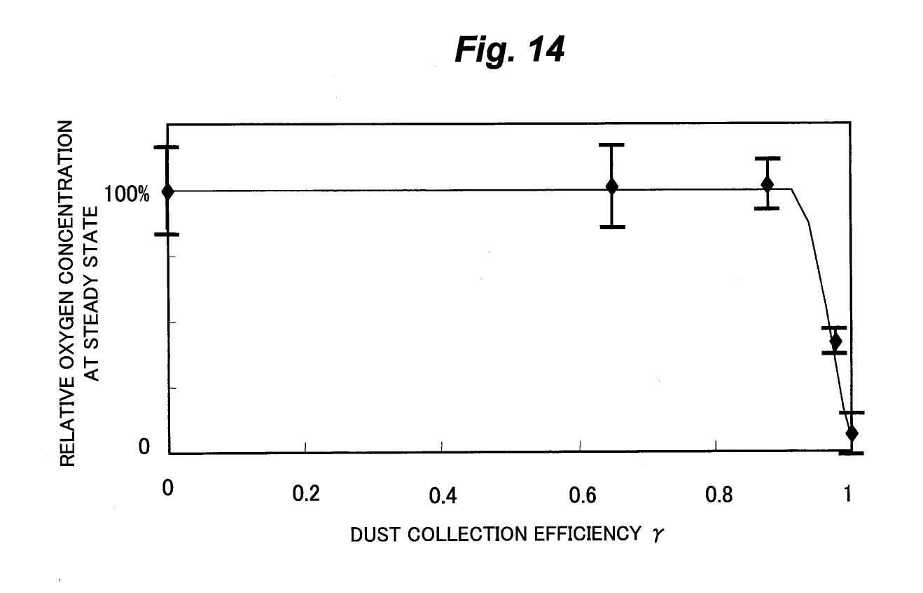

FIG. 14 shows the γ dependency of relative oxygen concentration in steady state. In case using partition wall materials of about A4-size area (about 0.06 m²) for sidewall area of about 0.4 m² through which gas molecules can pass, and in case the γ is less than or equal to 95%, it is proven that enough relative oxygen concentration can be obtained. Further, in case the γ is less than or equal to 95%, it is proven that relative oxygen concentration can be maintained to 1, but the γ is 95% or more, the relative oxygen concentration lowers from 1.

As shown above, in case using partition wall materials of about A4-size area (about 0.06 m²) for sidewall area of about 0.4 m² through which gas molecules can pass, and in case the γ is less than or equal to 90%, it is proven that dust particles reaches to zero count in about 40 minutes, and that enough oxygen concentration can be obtained. In case having other area parameters besides above, prospective design can be done by an equation.

γ′=1−S(1−γ)/S′

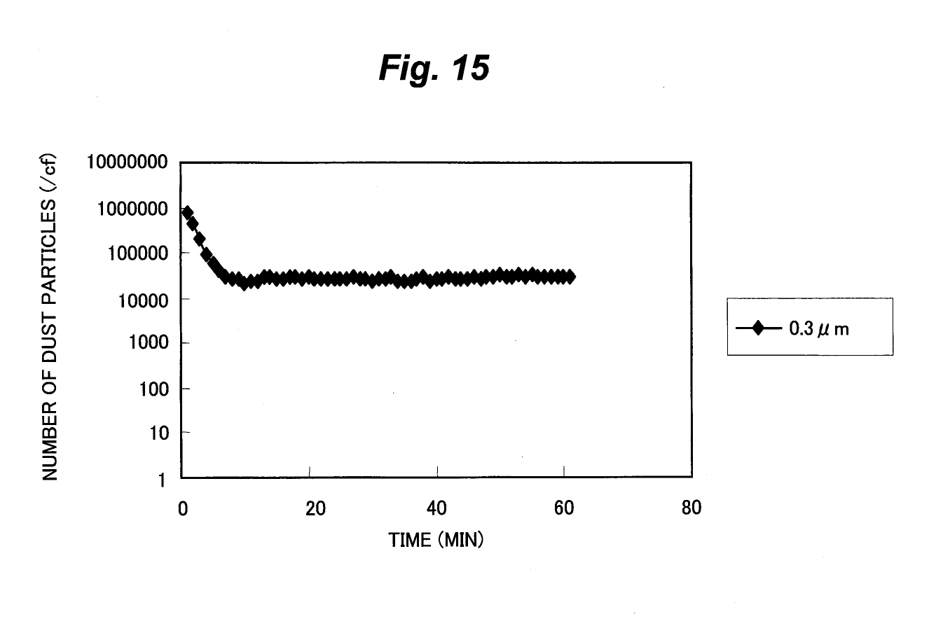

In order to investigate a case where the isobaric condition of Bernoulli's theorem (plane of the opening) is not satisfied, a dust counter 63 is put in the working chamber 41 of the clean unit 62 shown in FIG. 6A. (To correspond to the partition wall 45 in the experiment shown in FIG. 11) the opening 64 of the clean unit 62 is set to be open (no dust filter is fixed to the opening 64 and the opening 64 is completely open). FIG. 15 shows the time dependency of the number of dust particles under the above situation. In this case, gas flow at both sides of the opening 64 is asymmetric, that is, the gas flow velocity vector f (inside) in the working chamber 41 and the air flow velocity vector f (outside) at outside air flow passage at the vicinity of the opening 64 do not satisfy f (outside)˜f (inside). Accordingly, based on the Bernoulli's theorem, difference in pressure is produced and macroscopic mass-flow of gas penetrating the opening 64 is also produced. For this, outside air containing a large amount of dust particles pours into the working chamber 41, which shows that the number of counts of dust particles does not converge to zero of after passing enough time (Some thousands of dust particles are measured as shown in FIG. 15).

A clean unit according to the fourth embodiment of the present invention will be explained below.

The clean unit according to the fourth embodiment is the clean unit shown in FIG. 4, but a filter is not used at the partition wall 45, so the part is completely open. Starting operation of the dust filter 42 and the fan 52 fixed to the external gas flow passage 48, the air in the working chamber 41 flows into the inlet of the dust filter 42 via the feedback gas flow passage 43, and the dust particles are removed, and the air is purified. At the same time, outside air flows into the external gas flow passage 48 by the fan 52, and is exhausted from the exhaust opening 50. In case to make the flow velocity of gas in the feedback gas flow passage 43 and the external gas flow passage 48 equal, by the isobaric condition of Bernoulli's theorem, there is no gas flow into the feedback gas flow passage 43 from the external gas flow passage 48. Therefore, the dust particles contained in the outside air is not taken into the working chamber 41 through the feedback gas flow passage 43, thus the working chamber 41 maintains high cleanliness. The result shows marked contrast high cleanliness with the case shown in FIG. 15 (which has the same completely open opening, though), which shows a beneficial effect of this invention. Also, at this time, the oxygen taken from the outside air flows into the feedback gas flow passage 43 through the opening by diffusion, by which the oxygen concentration in the working chamber 41 can be maintained high.

The fourth embodiment is a case of γ=0% of the experiment results shown in FIGS. 11, 13 and 14, also, with regards to arrival time to zero count of dust particles and relative oxygen concentration, the nearly equal results are obtained in case using a dust filter of which γ is less than or equal to 90%.

A clean booth according to the fifth embodiment of the present invention will be explained below.

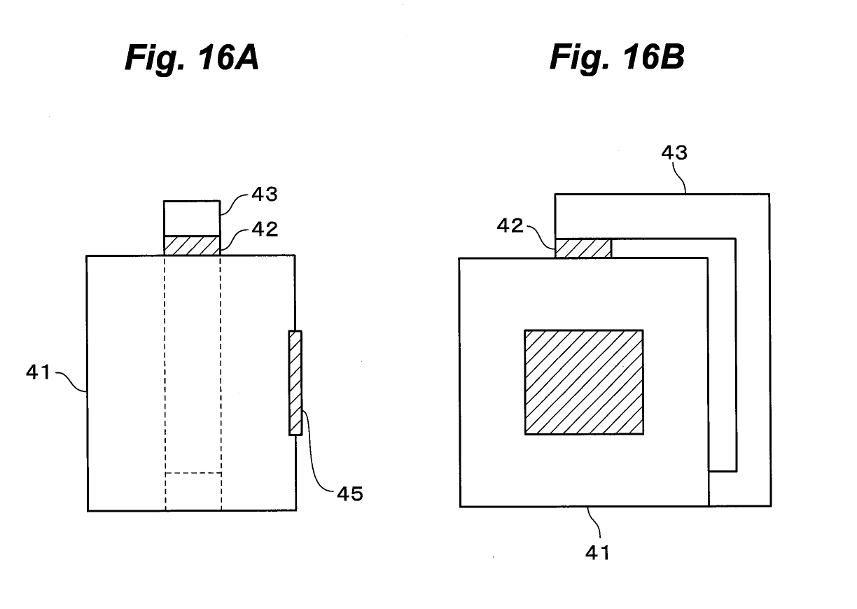

FIGS. 16A and 16B are a side elevation and a front view of this clean booth. The dust filter 42 with a blowing power source is fixed on the top surface of the working chamber 41, and the feedback gas flow passage 43 is fixed for connecting the dust filter 42 and the working chamber 41. As the dust filter 42, for example, a HEPA filter using glass fibers as filter material or an ULPA filter using polytetrafluoroethylene as filter material are used. Regarding the clean unit, the partition wall 45 is fixed at a part of the wall of the working chamber 41. As the outside air is taken into the inside of the working chamber 41 through the partition wall 45, enough oxygen concentration can be obtained, and when the dust collection efficiency of the partition wall 45 is sufficiently high, the inside of the working chamber 41 can be maintained to high cleanliness.

The size of the clean booth is, for example, 2 m in height, in width and in depth respectively. The area of the ceiling S_{c} is, for example, 4 m². Given a time scale that the cleanliness becomes the ISO class 1 in one and a half hours after starting operation of the dust filter 42, it would be better that the number of dust particles becomes 1/e in eight minutes, so the flow rate F would be better about 1 m³ per minute. At this time, when the homogeneous flow formation board 46 as shown in FIG. 3 is provided to the clean booth, uniform downflow can be obtained, and its wind velocity v is v=F/S_{c}=1 (m³/min.)/4 m²=0.25 m/min.=25 cm/60 s=4 mm/s. The wind velocity v is three orders of magnitude smaller in comparison with the v in the experiment carried out using an apparatus shown in FIGS. 6A and 6B, which is regarded as air flow vector f (inside)˜0 in the clean booth. On the other hand, it is regarded that the outside air of the clean booth remains almost stationary as small convective flow can be ignored, and satisfies the air flow vector f (outside)˜0 of the outside air of the clean booth. That is, under this operating condition, f (inside)=f (outside), and in accordance with the Bernoulli's theorem, macroscopic mass-flow of air through the partition wall 45 does not occur, the penetration of gas molecules only occurs by diffusion caused by concentration gradient. The partition wall 45 is made of such materials through which dust particles can not pass but gas molecules of oxygen, etc. can pass, and a dust filter such as a HEPA filter and a ULPA filter, a gas barrier film, etc. to be used for food packaging materials, and seal materials (a tape made of polytetrafluoroethylene, etc.) for plumbing connection to prevent leakage of gas.

A connected clean unit according to the sixth embodiment of the present invention will be explained.

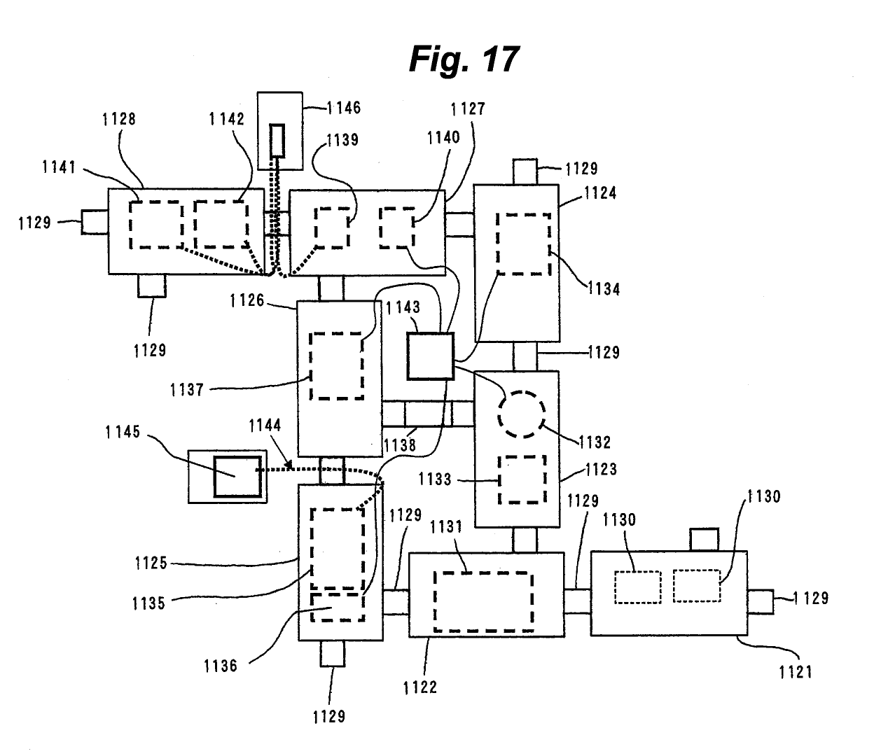

FIG. 17 shows the connected clean unit connecting a plurality of one kind or two and more kinds of clean units according to the first to fifth embodiments. As shown in FIG. 17, in the connected clean unit three-way connectable clean units 1121 to 1128 are connected via transfer boxes 1129. In this case the clean units 1122 to 1127 are connected in a loop.

The work to be carried out in each clean unit 1121 to 1128 is, for example, shown below. First, the clean unit 1121 is a store unit, and provided with a sample depository (for example, a wafer cassette 1130 holding substrates). The right lateral transfer box 1129 which is not used for connection is a slot to put sample, and the back surface transfer box 1129 which is also not used for connection is an emergency slot to take out samples. The clean unit 1122 is a chemical unit, and provided with a chemical pretreatment system 1131, and chemical pretreatment is carried out. The clean unit 1123 is a resist process unit, and provided with a spin coater 1132 and a development apparatus 1133, and a resist coating or development is carried out. The clean unit 1124 is a lithography unit, and provided with an exposure apparatus 1134, and a right lateral transfer box 1129 which is not used for connection is an emergency slot to take out samples. The clean unit 1125 is a growth and metallization unit, and provided with an electrochemical apparatus 1135 and a microreactor system 1136, and a right lateral transfer box 1129 which is not used for connection is an emergency slot to take out samples. The clean unit 1126 is an etching unit, and provided with an etching apparatus 1137. The transfer box 1129 provided at the back surface of the clean unit 1126 is connected to the transfer box 1129 provided at the back surface of the clean unit 1123 via a relay box 1138. The clean unit 1127 is an assembly unit and provided with a microscope 1139 and a prober 1140. The clean unit 1128 is a scanning probe microscope (SPM) observation unit and provided with a desktop STM 1141 and a desktop AFM 1142, and a right lateral transfer box 1129 which is not used for connection is a slot to take out samples, and the back surface transfer box 1129 which is also not used for connection is an emergency slot to take out samples. A spin coater 1132 of the clean unit 1123, an exposure apparatus 1134 of the clean unit 1124, an electrochemical apparatus 1135 and a microreactor system 1136 of the clean unit 1125, an etching apparatus 1137 of the clean unit 1126, and a prober 1140 of the clean unit 1127, etc. are connected to a power source 1143 and are supplied with a power source. The electrochemical apparatus 1135 of the clean unit 1125 is connected with an electrochemical apparatus controller 1145 by a signal cable 1144 and is controlled by the electrochemical apparatus controller 1145. Further, the observed images by the microscope 1139 of the clean unit 1127, and the desktop STM 1141 and the desktop AFM 1142 of the clean unit 1128 can be displayed on a liquid crystal display monitor 1146. Also, in each unit, for example, an experiment to promote streamlining of sericulture by using genetically modified silkworms can be carried out. Since there is no interference from outside environment, a cutting-edge biotechnology experiment is able to carry out in an environment without worrying about generation of gene crossover. Similarly, by such connections, poultry farming is carried out systematically without worrying about SARS infection.

With regards to the connected clean unit shown in FIG. 17, for example, any clean unit among the clean units according to the first to fifth embodiments is downsized and make it a portable clean unit. And, a sample (for example, a semiconductor wafer) is stored in a working chamber of the portable clean unit, and the transfer box of the portable clean unit with a sample in it is connected to a slot to take out samples of the clean unit 1128. In this situation, the sample can be transferred between the clean units connected platform systems existing at two points, which are widely separated, via a transfer box. Also, the sample can be carried from the portable clean unit to the clean unit 1128 and can be observed by the desktop STM 1141 or the desktop AFM 1142.

According to the aforementioned embodiments, there are many advantages. That is, almost all processes, such as a chemical pretreatment, a resist coating, exposure, development, growth and metallization, etching, probing, surface observation, etc., which are generally carried out making full use of a group of apparatuses installed in a huge clean room, can be realized simply and compactly in a normal laboratory scale room without using a large scale clean room in a clean unit providing local clean space, or a connected clean unit connecting clean booth in a loop or the like. Also, poultry farming, pig farming, etc. eliminated air infectiveness microbes can be realized, which enables to reduce menace for human society by parasitic zoonosis. In case of SARS outbreak in neighboring area, disposition of cultivating chickens is not required, which can not only promote productivity and economic efficiency but also respect the dignity of every life.

Heretofore, embodiments of the present invention have been explained specifically. However, the present invention is not limited to these embodiments, but contemplates various changes and modification based on the technical concept of the present invention, which is the clean unit completely closed against dusts and particles, and exchangeable for gas elements.

For example, the numerical number, materials, configuration, disposition, etc. mentioned in aforementioned embodiments are just examples, when necessary, the different numerical number, materials, configuration, disposition, etc. may be used.

As explained above, according to the present invention, by taking the outside air, for example, by a fan, into the external gas flow passage which is in contact with directly or in contact with through a partition wall with a feedback gas flow passage attached to a working chamber, oxygen (carbon dioxide) molecules can be taken into a working chamber (for example, a poultry farm, etc.) or (exhausts into a working chamber) by diffusion via the feedback gas flow passage from the external gas flow passage, and the oxygen (carbon dioxide) concentration in the working chamber can be maintained to the same oxygen (carbon dioxide) concentration in an enclosed environment. Also, by making the flow velocity vector of gas flowing in the feedback gas flow passage attached to the working chamber same with the flow velocity vector of gas flowing in the external gas flow passage, the gas flow velocity becomes equal at both sides of the partition wall, and the isobaric condition of Bernoulli's theorem is realized, macroscopic mass-flow of gas penetrating through the partition wall disappears, and the invasion of dust particles into the feedback gas flow passage from the external gas flow passage is prevented. Accordingly, the cleanliness of the working chamber does not deteriorate, and concentration of various gas such as oxygen, carbon dioxide, or the like can be maintained to the same concentration of a normal unenclosed environment. Therefore, it is possible to correspond for some processes like cultivation of living organisms which needs to prevent from decreasing oxygen concentration. At the same time, in case a working chamber is enlarged to a normal clean booth size, it is possible for an operator to work in the working chamber.

### DESCRIPTION OF REFERENCE NUMERALS

41 WORKING CHAMBER
41a RAISED FLOOR
41b, 41c, 47 VENTILATION HOLE
41d BASE
42, 42a, 42b DUST FILTER
43, 43a, 43b FEEDBACK GAS FLOW PASSAGE
44 PILLAR
45 PARTITION WALL
46 HOMOGENEOUS FLOW FORMATION BOARD
48 EXTERNAL GAS FLOW PASSAGE
49 AIR BLOWER
52 FAN
63 DUST COUNTER

1-5. (canceled)

6. A clean unit comprising:
a working chamber capable of controlling or maintaining the number of dusts or number of microbes in the working chamber,
a part of the working chamber being constituted with a partition wall through which gas molecules can pass,
the flow velocity vector of gas inside the working chamber and the flow velocity vector of gas outside the working chamber being made to be almost symmetric at both sides of the partition wall at the vicinity of the partition wall.

7. A clean unit comprising:
a working chamber capable of controlling or maintaining the number of dusts or number of microbes in the working chamber,
a part of the working chamber being constituted with a partition wall through which gas molecules can pass,
the flow velocity vector of gas inside the working chamber and the flow velocity vector of gas outside the working chamber having finite magnitude and being made to be almost symmetric at both sides of the partition wall at the vicinity of the partition wall.

8. A clean unit comprising:
a working chamber capable of controlling or maintaining the number of dusts or number of microbes in the working chamber; and
a gas flow passage for connecting air-tightly a ventilation hole formed in the working chamber and another ventilation hole formed in the working chamber,
an external gas flow passage being provided in contact with the gas flow passage, and the external gas flow passage and the gas flow passage communicating each other through a partition wall through which gas molecules can pass,
the flow velocity vector of gas inside the gas flow passage and the flow velocity vector of gas outside the external gas flow passage being made to be almost symmetric at both sides of the partition wall.

9. (canceled)
